(19) United States
(12) Patent Application Publication
(10) Pub. No.: US 2006/0198483 A1
(43) Pub. Date: Sep. 7, 2006

(54) Magnetized plasma fusion reactor

(75) Inventor: Michel Georges Laberge, Bowen Island (CA)

Correspondence Address: KOLISCH HARTWELL, P.C., 200 PACIFIC BUILDING, 520 SW YAMHILL STREET, PORTLAND, OR, 97204, US

(73) Assignee: General Fusion Inc.

(21) Appl. No.: 11/073,276

(22) Filed: Mar. 4, 2005

(51) Int. Cl. H05H 1/22

(52) U.S. Cl. 376/100

(57) ABSTRACT

A fusion reactor apparatus for initiating a fusion reaction in a fusionable material is disclosed. The apparatus includes a vessel operable to contain a liquid medium and a vortex generator operable to generate a vortex in the liquid medium. The apparatus also includes a plasma generator operable to generate a magnetized plasma of the fusionable material and to introduce the magnetized plasma into the vortex and a pressure wave generator operably configured to cause a pressure wavefront in the liquid medium to envelope the magnetized plasma and to converge on the magnetized plasma to impart sufficient energy to the fusionable material to initiate fusion in the fusionable material.

This application is related to the US Patent application entitled “Pressure Wave Generator and Controller For Generating a Pressure Wave in a Fusion Reactor” by Laberge et al., filed concurrently herewith and incorporated herein by reference.

### BACKGROUND OF THE INVENTION

1. Field of Invention

This invention relates to nuclear fusion reactors and more particularly to a fusion reactor that initiates fusion reactions in a magnetized plasma of fusionable material.

2. Description of Related Art

Nuclear fusion reactions involve bringing together atomic nuclei against their mutual electrostatic repulsion and fusing them together to make heavier nuclei, while at the same time releasing energy. Isotopes of light elements (i.e. elements having a relatively small number of protons) are the easiest to fuse, because the electrostatic repulsion between the nuclei of light elements is smaller than that of heavier elements. The use of light elements may produce significantly reduced collateral radioactivity than comparable fission reactors, which typically use isotopes of heavier elements.

Inducing nuclear fusion reactions is difficult, because of the energies required to accelerate the nuclei to speeds fast enough to overcome their mutual electrostatic repulsion and because the nuclei are so small that the chance that two passing nuclei will interact with one another in a manner which results in fusion of the nuclei is small.

Fusion reactors typically require input energy to initiate fusion reactions. The amount of input energy required is largely determined by the need to accelerate the nuclear reactants to thermonuclear speed and to confine the nuclear reactants in a space that allows them to interact. A reactor that consumes less energy than it produces is said to produce net energy. Such a reactor will have an efficiency ratio (the ratio of energy output to the energy input) greater that unity. The energy output of a fusion reactor is largely determined by the number of fusion reactions that are induced in the reactor and the amount of energy that is released and captured.

There remains a need for methods and apparatus that facilitate improvements to the efficiency of nuclear fusion reactors.

### SUMMARY OF THE INVENTION

In accordance with one aspect of the invention there is provided a method of initiating a fusion reaction in a magnetized plasma of fusionable material located in a vortex in a liquid medium. The method involves causing a pressure wavefront in the liquid medium to envelope the magnetized plasma and to converge on the magnetized plasma to impart sufficient energy to the fusionable material to initiate fusion in the fusionable material.

Causing the pressure wavefront to envelope and converge may involve generating a pressure wave having a substantially spherical wavefront.

Causing the pressure wavefront to envelope and converge may involve generating a pressure wave having a wavefront that converges on a position at the center of the vortex.

Causing the pressure wavefront to envelope and converge may involve generating a plurality of pressure waves, the plurality of pressure waves combining to form the pressure wavefront.

Generating the plurality of pressure waves may involve causing a plurality of moveable pistons to impact an outside surface of a vessel containing the liquid medium.

Causing the plurality of moveable pistons to impact the outside surface of the vessel may involve accelerating the moveable pistons from respective initial positions, the respective initial positions being spaced apart from the vessel.

Accelerating the moveable pistons from the respective initial positions may involve applying a fluid pressure thereto.

The method may involve generating a poloidal magnetic field in the fusionable material such that the fusionable material is confined by the poloidal magnetic field.

The method may involve introducing the magnetized plasma into the vortex.

Introducing the magnetized plasma may involve propelling the magnetized plasma into an open end of the vortex.

Propelling the magnetized plasma may involve generating a toroidal magnetic field that interacts with the magnetized plasma to impart a force thereon.

Causing the pressure wavefront to envelope and converge may involve generating a pressure wave having a wavefront that reaches a target position in the vortex after the magnetized plasma has reached the target position in the vortex.

The method may involve generating a first magnetized plasma and generating a second magnetized plasma.

The method may involve introducing the first magnetized plasma into a first open end of the vortex and introducing the second magnetized plasma into a second open end of the vortex.

The method may involve causing the first magnetized plasma and the second magnetized plasma to collide at a target position located substantially midway between the first and the second open ends of the vortex.

Causing the pressure wavefront to envelope and converge may involve generating a pressure wave having a wavefront that reaches the target position after the first magnetized plasma and the second magnetized plasma have collided at the target position.

Causing the first magnetized plasma and the second magnetized plasma to collide may involve generating respective toroidal magnetic fields in the magnetized plasmas, the respective toroidal magnetic fields causing respective propelling forces to be imparted on the first and the second magnetized plasmas.

Generating respective toroidal magnetic fields may involve generating respective toroidal magnetic fields that are oriented such that when the first and the second magnetized plasmas collide, the respective toroidal magnetic fields are cancelled, causing magnetic energy to be converted into heat energy in the first and said second magnetized plasmas.

The liquid medium may be contained in a vessel having a generally circular cross section and the method may involve generating the vortex by causing the liquid medium to be rotated about an axis of the vessel.

The method may involve applying a vacuum to the vortex to evacuate the vortex.

Causing the liquid medium to be rotated may involve extracting a portion of the liquid medium from the vessel through an aperture located in the vessel proximate the axis and causing the portion of the liquid medium to be re-introduced into the vessel as a plurality of flow streams oriented in a direction aligned with a desired rotational direction of the liquid medium.

Causing the liquid medium to be rotated may involve orienting the flow streams such that a substantially uniform rotational velocity is imparted to all portions of the liquid medium.

In accordance with another aspect of the invention there is provided a fusion reactor apparatus for initiating a fusion reaction in a fusionable material. The apparatus includes a vessel for containing a liquid medium and provisions for generating a vortex in the liquid medium. The apparatus also includes provisions for introducing a magnetized plasma of the fusionable material into the vortex and provisions for causing a pressure wavefront in the liquid medium to envelope the magnetized plasma and to converge on the magnetized plasma to impart sufficient energy to the fusionable material to initiate fusion in the fusionable material.

The provisions for causing the pressure wavefront to envelope and converge may include provisions for generating a pressure wave having a substantially spherical wavefront.

The provisions for causing the pressure wavefront to envelope and converge may include provisions for generating a pressure wave having a wavefront that converges on a position at the center of the vortex.

The provisions for causing the pressure wavefront to envelope and converge may include provisions for generating a plurality of pressure waves, the plurality of pressure waves combining to form the pressure wavefront.

The provisions for generating the plurality of pressure waves may include provisions for causing a plurality of moveable pistons to impact an outside surface of the vessel.

The provisions for causing the plurality of moveable pistons to impact the outside surface of the vessel may include provisions for accelerating the moveable pistons from respective initial positions, the respective initial positions being spaced apart from the vessel.

The provisions for accelerating the moveable pistons from the respective initial positions may include provisions for applying a fluid pressure thereto.

The apparatus may include provisions for generating a magnetized plasma.

The provisions for generating the magnetized plasma may include provisions for generating a poloidal magnetic field in the fusionable material such that the fusionable material is confined by the poloidal magnetic field.

The provisions for introducing the magnetized plasma may include provisions for propelling the magnetized plasma into an open end of the vortex.

The provisions for propelling the magnetized plasma may include provisions for generating a toroidal magnetic field that interacts with the magnetized plasma to impart a force thereon.

The provisions for causing the pressure wavefront to envelope and converge may include provisions for generating a pressure wave having a wavefront that reaches a target position in the vortex after the magnetized plasma has reached the target position in the vortex.

The provisions for generating the magnetized plasma may include provisions for generating a first magnetized plasma and provisions for generating a second magnetized plasma.

The apparatus may include provisions for introducing the first magnetized plasma into a first open end of the vortex and provisions for introducing the second magnetized plasma into a second open end of the vortex.

The apparatus may include provisions for causing the first magnetized plasma and the second magnetized plasma to collide at a target position located substantially midway between the first and the second open ends of the vortex.

The provisions for causing the pressure wavefront to envelope and converge may include provisions for generating a pressure wave having a wavefront that reaches the target position after the first magnetized plasma and the second magnetized plasma have collided at the target position.

The provisions for causing the first magnetized plasma and the second magnetized plasma to collide may include provisions for generating respective toroidal magnetic fields in the magnetized plasmas, the respective toroidal magnetic fields operable to cause respective propelling forces to be imparted on the first and the second magnetized plasmas.

The provisions for generating respective toroidal magnetic fields may be operably configured to generate respective toroidal magnetic fields that are oriented such that when the first and the second magnetized plasmas collide, the respective toroidal magnetic fields are cancelled, causing magnetic energy to be converted into heat energy in the first and said second magnetized plasmas.

The provisions for generating the vortex may include provisions for causing the liquid medium to be rotated about an axis of the vessel.

The apparatus may include provisions for applying a vacuum to the vortex to evacuate the vortex.

In accordance with another aspect of the invention there is provided a fusion reactor apparatus for initiating a fusion reaction in a fusionable material. The apparatus includes a vessel operable to contain a liquid medium and a vortex generator operable to generate a vortex in the liquid medium. The apparatus also includes a plasma generator operable to generate a magnetized plasma of the fusionable material and to introduce the magnetized plasma into the vortex and a pressure wave generator operably configured to cause a pressure wavefront in the liquid medium to envelope the magnetized plasma and to converge on the magnetized plasma to impart sufficient energy to the fusionable material to initiate fusion in the fusionable material.

The vessel may be substantially spherical and the pressure wave generator may be operable to generate a pressure wave having a substantially spherical wavefront.

The pressure wave generator may include a plurality of moveable pistons operably configured to impact an outside surface of the vessel to generate a plurality of pressure waves, the plurality of pressure waves combining to form the pressure wavefront.

The plasma generator may include a magnetic field generator for generating a poloidal magnetic field in the fusionable material, the poloidal field being operable to confine the fusionable material.

The plasma generator may include a toroidal magnetic field generator for generating a toroidal magnetic field for propelling the magnetized plasma into the vortex by interacting with the magnetized plasma to impart a force thereon.

The pressure wave generator may be operably configured to generate a pressure wave having a wavefront that reaches a target position in the vortex after the magnetized plasma has reached the target position in the vortex.

The target position may be located at a center of the vortex.

The plasma generator may include a first plasma generator for generating a first magnetized plasma and a second plasma generator for generating a second magnetized plasma.

The first plasma generator may be located on a first wall portion and the second plasma generator may be located on a second wall portion, the first and the second wall portions being joined by a third wall portion, the first and the second wall potions having a frustoconical shape facilitating introduction of the magnetized plasma into the vortex after causing the pressure wavefront to envelope and converge in the liquid medium.

The vortex may have first and second open ends located on opposite sides of the vortex and the first plasma generator may be disposed to introduce the first magnetized plasma into the first open end of the vortex and the second plasma generator may be disposed to introduce the second magnetized plasma into the second open end of the vortex.

The first plasma generator and the second plasma generator may have respective toroidal field generators, the respective field generators being operably configured to impart respective forces on the first and the second magnetized plasmas such that the first magnetized plasma and the second magnetized plasma collide at a target position located substantially midway between the first and the second open ends of the vortex.

The pressure wave generator may be operably configured to generate a pressure wave having a wavefront that reaches the target position after the first magnetized plasma and the second magnetized plasma have collided at the target position.

The respective toroidal field generators may be operably configured to generate respective toroidal magnetic fields that are oriented such that when the first and the second magnetized plasmas collide, the respective toroidal magnetic fields are cancelled, causing magnetic energy to be converted into heat energy in the first and said second magnetized plasmas.

The vortex generator may be operably configured to cause the liquid medium to be rotated about an axis of the vessel.

The vortex generator may include a first aperture in the vessel proximate the axis, a plurality of jets located inside the vessel and a pump for extracting the liquid medium through the aperture and for reintroducing the liquid medium into the vessel through the plurality of jets, the jets being oriented in a direction aligned with a desired rotational direction of the liquid medium.

The apparatus may include a vacuum source in communication with the vortex for evacuating the vortex.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of a fusion reactor according to a first embodiment of the invention;

FIG. 2 is a cross-sectional view of the fusion reactor shown in FIG. 1, taken along line 2-2;

FIG. 3 is a cross-sectional view of the fusion reactor shown in FIG. 1, taken along line 3-3;

FIG. 4 is a cross sectional view of a plasma generator used in the fusion reactor shown in FIG. 1;

FIGS. 5-7 are a series of schematic views of the operation of the fusion reactor shown in FIG. 1;

FIG. 8 is a flowchart of a process for operating the fusion reactor shown in FIG. 1;

FIGS. 9-16 are a series of views illustrating the operation of the plasma generator shown FIG. 4;

FIG. 17 is a schematic view of magnetized plasmas produced in the operation of the fusion reactor shown in FIG. 2;

FIG. 18 is a schematic view of a combined magnetized plasma produced in the operation of the fusion reactor shown in FIG. 2; and

FIG. 19 is a cross-sectional view of a fusion reactor according to another embodiment of the invention.

### DETAILED DESCRIPTION

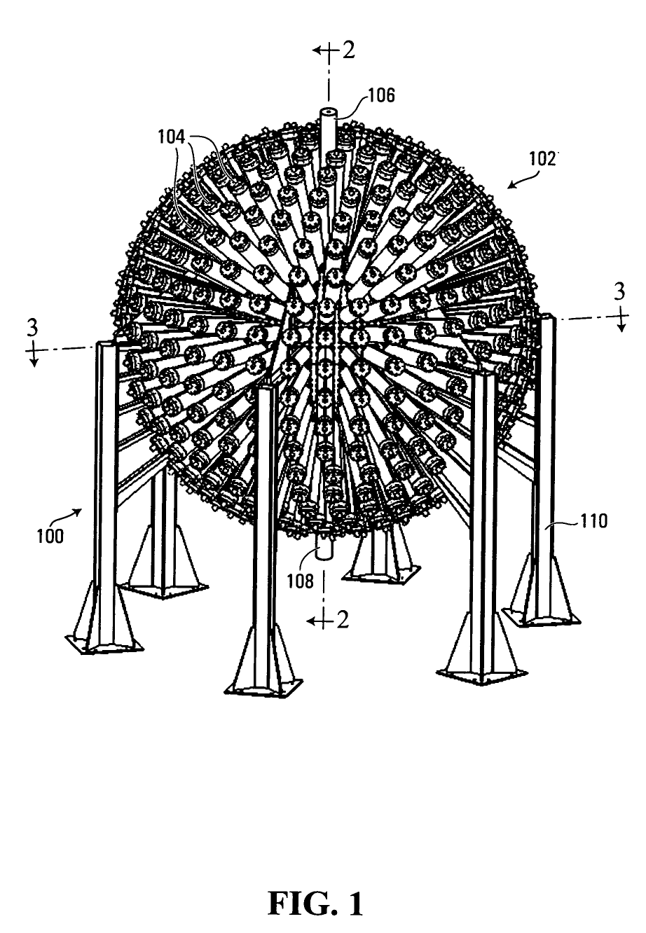

Referring to FIG. 1, a fusion reactor according to a first embodiment of the invention is shown generally at 100. The fusion reactor 100 includes a vessel 102, a plurality of pressure wave generators 104, a first plasma generator 106, and a second plasma generator 108. The vessel 102 also includes a plurality of mounts 110 for supporting the vessel.

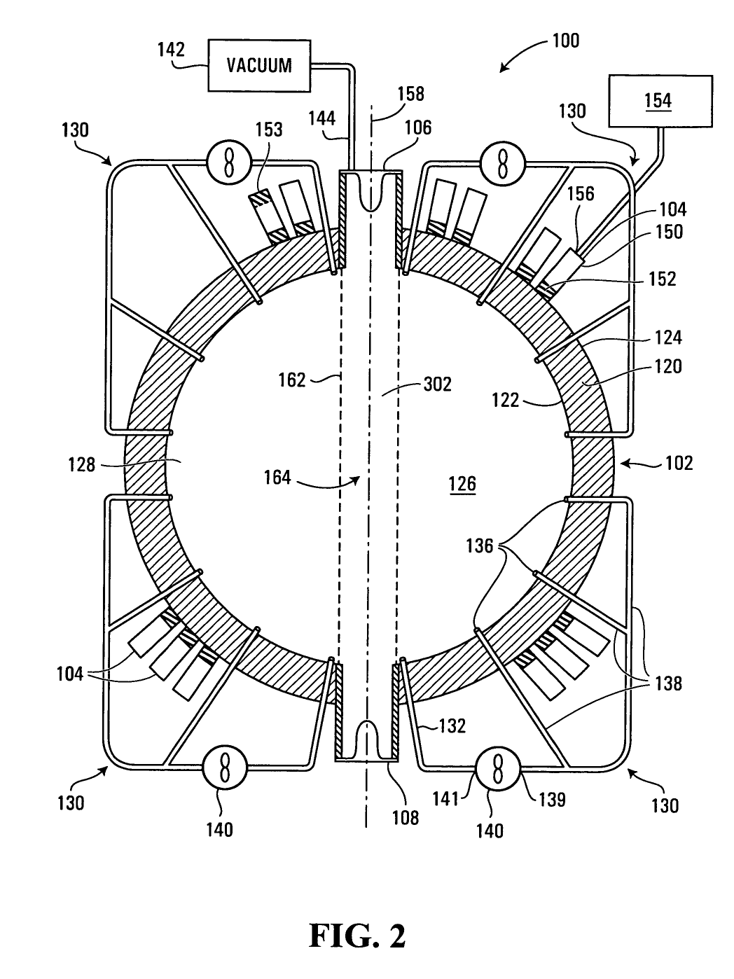

Referring to FIG. 2, the fusion reactor 100 is shown in greater detail in a sectional view. The vessel 102 includes a wall 120, which has an inside surface 122 and an outside surface 124. The inside surface 122 of the wall 120 defines an inner cavity 126, which contains a liquid medium 128. The liquid medium 128 may be a molten metal, such as lead, lithium, or sodium, or an alloy of such metals. The liquid medium 128 may also contain additives that enhance the properties thereof, for example by enhancing neutron shielding or increasing the density of the liquid medium.

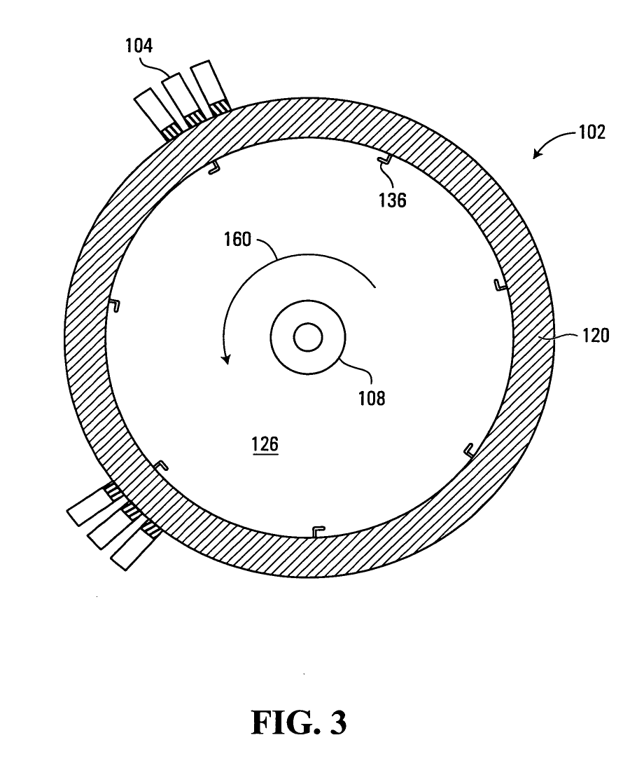

The fusion reactor 100 further includes a plurality of vortex generators 130. Each vortex generator 130 includes an outlet conduit 132, a plurality of jets 136 in communication with inlet conduits 138, and a pump 140. The pump 140 includes an intake 141 and an outlet 139. The intake 141 of the pump 140 is in communication with the outlet conduit 132 and the outlet 139 of the pump is in communication with the inlet conduits 138. The jets 136, on the right hand side of the fusion reactor 100 in FIG. 2, are oriented into the page while the jets on the left hand side of the fusion reactor are oriented out of the page. The orientation of a portion of the plurality of jets 136 is more clearly depicted in the cross-sectional view of FIG. 3.

The fusion reactor 100 also includes a vacuum conduit 144 and a vacuum pump 142. The vacuum conduit 144 is in communication with the inner cavity 126 and the vacuum pump 142 is in communication with the vacuum conduit.

The pressure wave generators 104 are located on the outside surface 124 of the wall 120 (only some of the pressure wave generators are shown for clarity). Each pressure wave generator 104 includes a housing 150, a piston 152 which is moveable in the housing and capable of impacting the wall 120 to cause a pressure wave to be generated in the liquid medium. Each pressure wave generator 104 further includes a fluid port 156, in communication with a source of pressurised fluid 154, for applying a fluid pressure to the housing 150 to actuate the piston 152. Each pressure wave generator 104 may be independently controllable, allowing respective pistons to impact the wall 120 at a desired time and with a desired amount of kinetic energy. The kinetic energy due to the piston impact causes a compression wave in the wall 120 which travels through the wall and into the liquid medium 128, thus generating the pressure wave in the liquid medium. In some embodiments the wall 120 may include a moveable transducer (not shown) in the wall 120, the moveable transducer being coupled to the liquid medium 128. The transducer operates by receiving kinetic energy from the piston 152 and converting the kinetic energy into a pressure wave in the liquid medium. A suitable pressure wave generator and transducer is described in the related patent application entitled “Pressure Wave Generator and Controller For Generating a Pressure Wave in a Fusion Reactor” by Laberge et al.

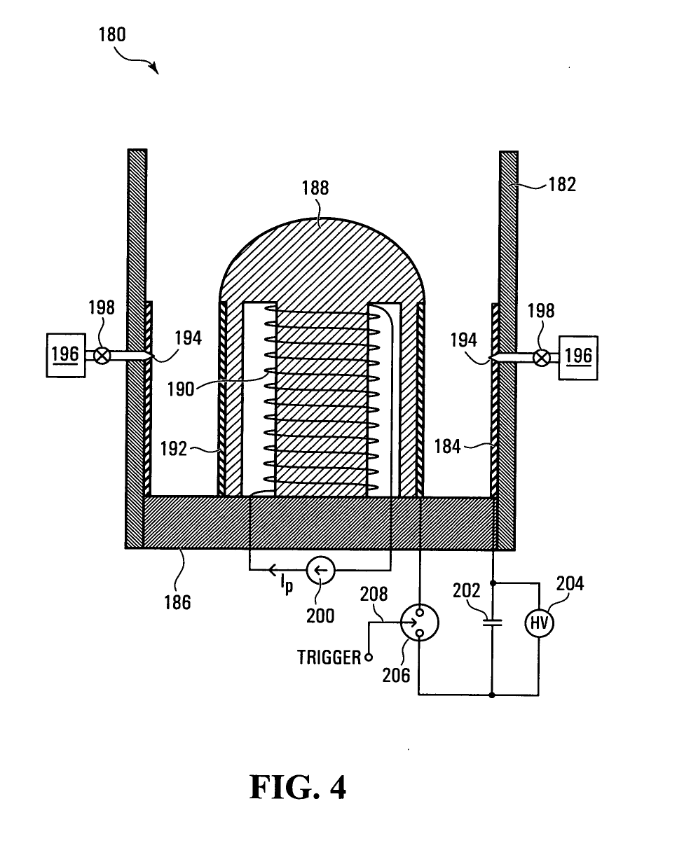

The plasma generators 106 and 108 are located in the wall 120 of the vessel 102 in communication with the inner cavity 126. Referring to FIG. 4, an exemplary plasma generator is shown at 180. The plasma generator 180 includes a cylindrical housing 182 and a cylindrical outer electrode 184, which is mounted on an inside surface of the cylindrical housing. The plasma generator 180 further includes an insulating base 186 and a central former 188. The central former 188 is mounted on the insulating base and is coaxially located with respect to the outer electrode 184. At least a portion of the central former 188 includes a material having a high permeability for concentrating a magnetic field. The plasma generator 180 further includes a coil 190 wound around the central former 188 and an inner cylindrical electrode 192 located on the outside of the central former.

The plasma generator 180 also includes a plurality of nozzles 194 (of which only two are shown). The nozzles 194 are radially oriented with respect to the cylindrical housing 182 and located around the periphery thereof. The plasma generator 180 further includes a plurality of fusionable material reservoirs 196 in communication with respective nozzles 194 through respective fast acting valves 198. Alternatively the plurality of nozzles 194 may be in communication with a single fusionable material reservoir through a single fast acting value. The fast acting valves may be of the type described by T. W. Kornack in the publication “Magnetic Reconnection studies on SSX”, Swathmore College Department of Physics and Astronomy, Jun. 10, 1998, which is incorporated herein by reference.

The plasma generator 180 further includes a current source 200 for supplying a current Iₚ to the coil 190. The plasma generator 180 also includes a capacitor 202, a high voltage supply 204 for charging the capacitor 202, and a spark gap switch 206. The capacitor 202 is coupled between the inner electrode 192 and the outer electrode 184 via the spark gap switch 206. The high voltage supply 204 is connected across the capacitor 202. The high voltage power supply 204 may be operable to charge the capacitor to a voltage of about 10 kV. The spark gap switch 206 includes a trigger electrode 208, which is coupled to a trigger control signal.

The fusion reactor 100 may further include a recirculation system (not shown) for reticulating the liquid medium 128 and for extracting heat generated by the fusion reaction. The extracted heat may be used to drive a steam turbine for generating electrical power.

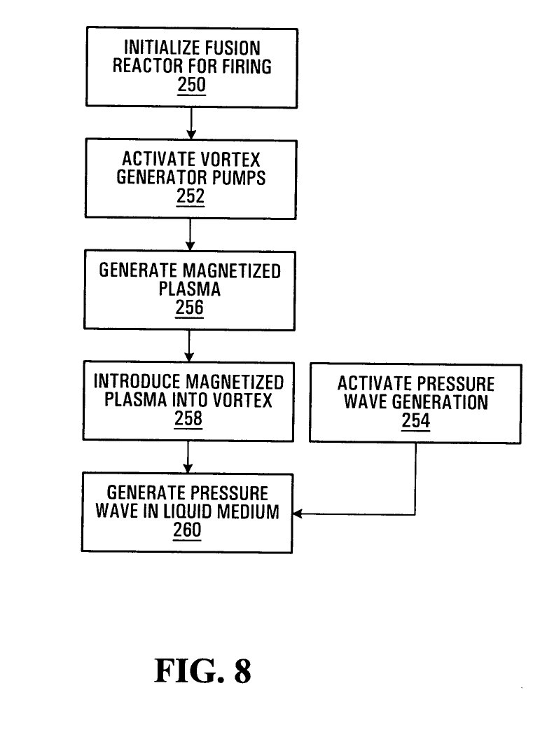

The operation of the fusion reactor will now be explained with reference to FIG. 2, FIG. 3, and FIG. 8. FIG. 8 depicts a process of operating the fusion reactor 100 according to one embodiment of the invention. As shown at 250 the fusion reactor is initialized by initializing the plurality of pressure wave generators 104 such that their respective pistons 152 are positioned in spaced apart relation to the wall 120 of the vessel 102 (an initial position of one of the pistons 152 is shown in broken outline at 153). The inner cavity 126 of the vessel 102 is not completely filled with the liquid medium 128, thus providing an unfilled space in the inner cavity for generation of a vortex as described below. The vacuum pump 142 is also activated so that the unfilled space is evacuated prior to generating the vortex 162, thus removing potential impurities from the vortex. Impurities such as Oxygen (O₂) and Nitrogen (N₂) may produce hazardous radioactive isotopes and ionized O₂ and N₂ produce x-ray and visible radiation that may cool the plasma prior to initiating fusion reactions therein.

As shown at 252 the pumps 140 of the vortex generators 130 are activated, causing a portion of the liquid medium 128 to be extracted from the inner cavity 126 through the outlet conduits 132. The portion of the liquid medium 128 that is extracted is re-introduced into the inner cavity 126 through the jets 136. The jets 136 are oriented so as to cause the liquid medium to be rotated about a vertical axis 158 of the vessel 102 (The rotation is indicated in the horizontal sectional view of FIG. 3 by the arrow 160). The extracting of the liquid medium 128 from the inner cavity 126 and the rotation of the liquid medium combines to generate a tubular vortex 162, which is coaxially aligned with the vertical axis 158.

The extent of the vortex 162 is dependent on the volume of the unfilled space in the cavity prior to commencing vortex generation. Since the liquid medium is not easily compressible, the volume of the vortex 162 will be similar to the unfilled space in the inner cavity 126. The inner cavity 126 may thus be filled such that the vortex 162 will have a diameter that is approximately the same as a diameter of the cylindrical housing 182 of the plasma generator 180 (shown in FIG. 4). In one embodiment the diameter of the vortex may be 10 cm. Furthermore, the shape of the vortex 162 may also be adjusted by adjusting the location and flow rate of each of the jets 136 to compensate for the effect of gravity on the vortex shape, for example.

As shown at 256, the plasma generators 106 and 108 are activated to generate respective magnetized plasmas. Plasma is a good conductor of electrical current and will react to a magnetic field, but otherwise has properties similar to the constituents, which in this case include fusionable materials which may be in a gaseous state. However, in the absence of some confining boundary or force, such as a magnetic field, a plasma will quickly dissipate.

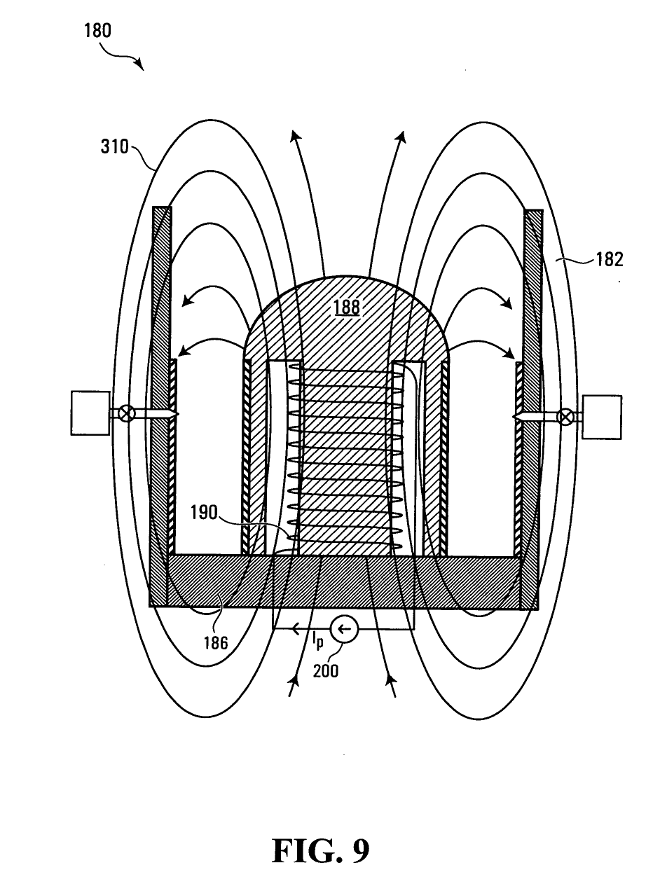

The operation of the plasma generators 106 and 108 is explained with reference to FIGS. 9-14. Referring to FIG. 9, the current source 200 of plasma generator 180 applies a direct current Iₚ to the coil 190. The current Iₚ generates a so-called stuffing magnetic field represented in FIG. 9 by field lines 310. The stuffing magnetic field is cylindrically symmetrical and is concentrated by the central former 188 which has a high magnetic permeability.

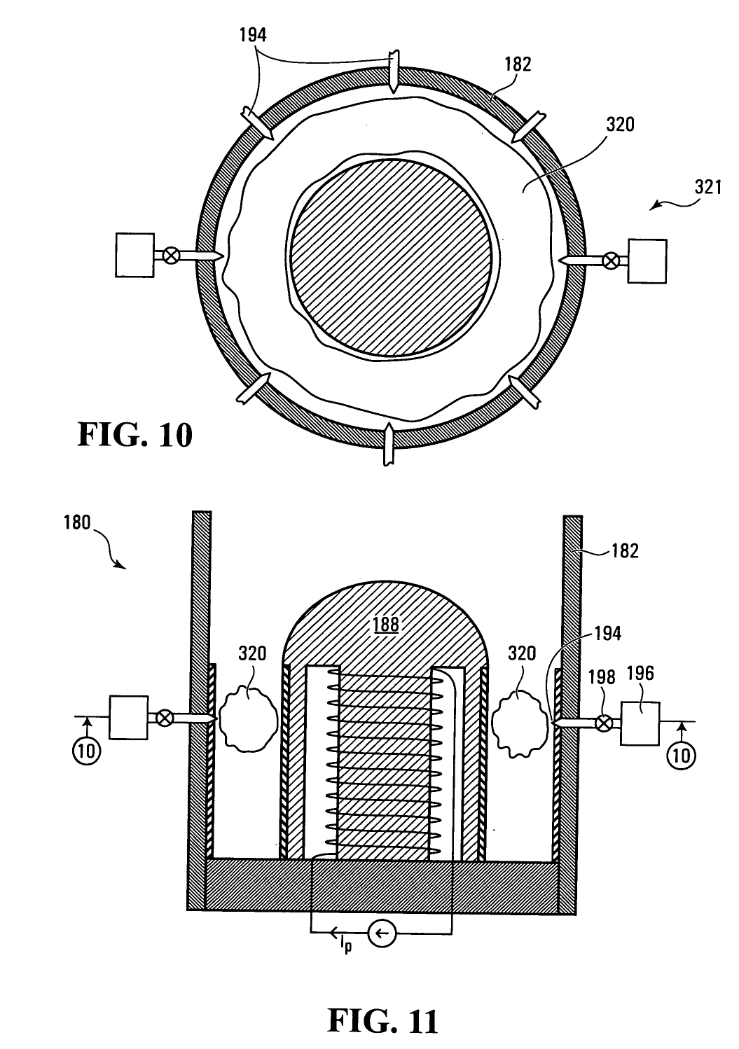

Referring to FIG. 11, a quantity of fusionable material 320 is introduced from the fusionable material reservoir 196 into the plasma generator 180 through the nozzles 194. The fast acting valves 198 ensure that a precise quantity of the fusionable material 320 is introduced. At the time of introduction, the fusionable material 320 is not yet ionized and is not confined. The fusionable material 320 is introduced simultaneously through multiple nozzles 194 (shown more clearly in cross-section detail in FIG. 10 at 321). The symmetrical introduction of the fusionable material 320 causes an annular cloud of fusionable materials to be formed in the plasma generator 180. In FIG. 10, and several subsequent figures, the magnetic field lines 310 have been omitted for sake of clarity but it should be understood that the current Iₚ continues to flow throughout the generation process thus generating a persistent stuffing magnetic field.

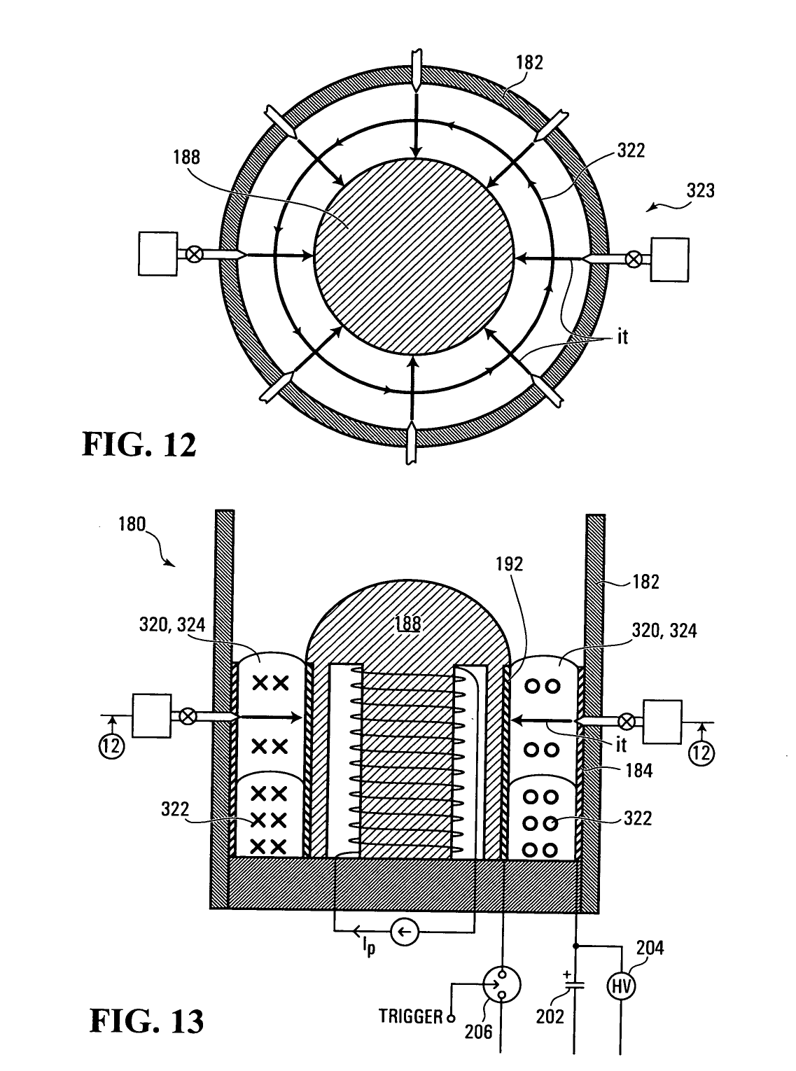

Referring to FIG. 13 the fusionable material 320 will diffuse to at least partially fill the region between the inner electrode 192 and the outer electrode 184 of the plasma generator 180. Prior to introduction of the fusionable material 320, the capacitor 202 is charged to a voltage V by the high voltage supply 204. Initially no current flows due to the presence of the spark gap switch 206 that is connected in series with the capacitor. Once the fusionable material 320 has diffused to at least partially fill the region between the inner electrode 192 and the outer electrode 184, a trigger signal is generated and coupled to the trigger electrode 208 of the spark gap switch 206, causing a current iₜ to flow between the outer electrode 184 and the inner electrode 192, thus ionizing the fusionable material 320. The current iₜ also generates a toroidal magnetic field, represented in FIG. 13 by field lines 322 (field lines 322 flow into the page (indicated by “x”) and out of the page (indicated by “o”)). The orientation of the current iₜ and the toroidal magnetic field (indicated by the field lines 322) is more clearly depicted in cross-sectional detail view shown in FIG. 12 at 323 (taken along cross section line 12-12 through the plasma generator shown at 180, looking in the direction indicated by the corresponding arrows).

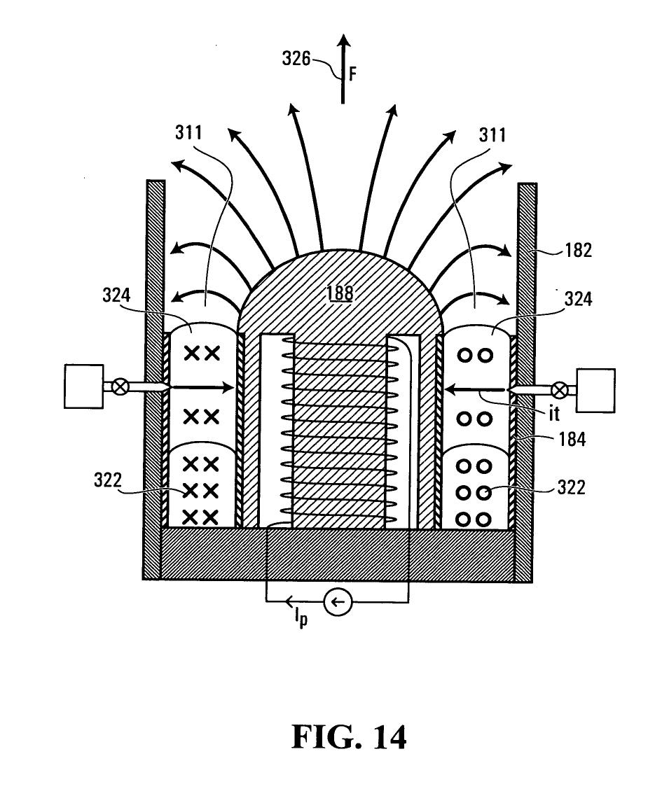

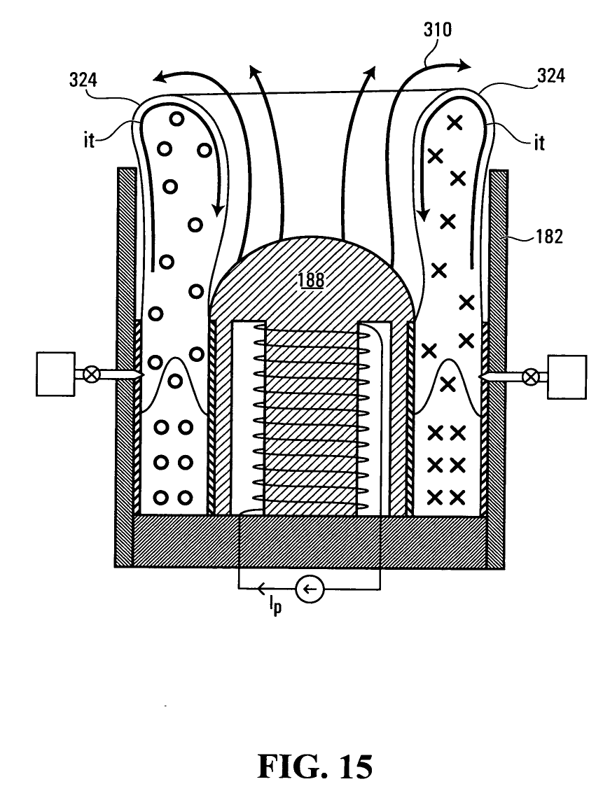

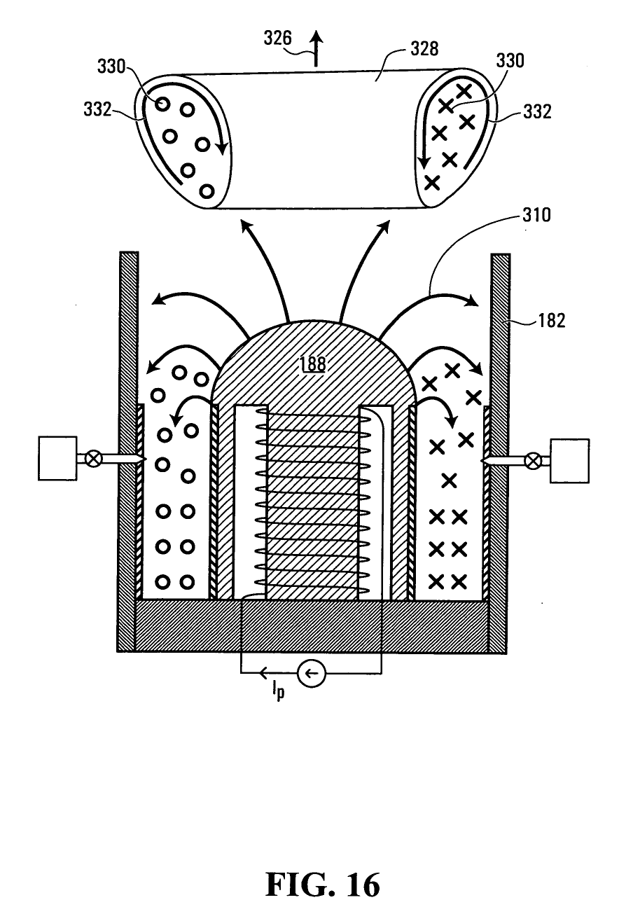

Referring now to FIG. 14, the current iₜ interacts with the toroidal magnetic field to cause a force to be imparted on the plasma 324. The force is given by:
\vec{F}=\vec{B}×\vec{i}ₜ Equation 1
where \vec{B} is the magnetic flux density of the toroidal magnetic field. For the direction of current flow iₜ shown in FIG. 14, the force imparted on the plasma 324 is in the direction indicated by the arrow 326. The force displaces the plasma 324 in the direction of the arrow 326 causing the plasma to encounter and interact with the stuffing magnetic field. For an operable plasma generator 180, the force F is generated so that the plasma 324 has sufficient momentum to overcome a tension force due to the stuffing magnetic field, and thus the magnetic field indicated by field lines 310 in the region 311 are deformed and weakened by the advancing plasma. Referring to FIG. 15, the force F continues to displace the plasma 324, further weakening the field lines 310 of stuffing magnetic field in the region behind the plasma 324. Referring to FIG. 16, the plasma 324 eventually breaks free of the stuffing magnetic field thus forming a separated magnetized plasma 328, having a velocity in the direction of the arrow 326. The separated magnetized plasma 328 includes a toroidal magnetic field component 330, inherited from the toroidal magnetic field due to the current iₜ, and a poloidal magnetic field component 332 due to the interaction of the plasma 324 with the stuffing magnetic field.

From Equation 1, it is evident that the force imparted on the plasma 324, may be increased by increasing the current iₜ, which in turn may be increased by increasing the voltage V supplied by the voltage supply 204 or by increasing the capacitance of the capacitor 202. However, the velocity in the direction of the arrow 326 is also affected by magnetic flux density of the stuffing magnetic field through which the plasma 324 must break in order to produce the separated magnetized plasma 328. The stuffing magnetic field strength and the toroidal magnetic field strength may be selected to achieve a desired degree of confinement of the plasma 324 and a desired magnetized plasma velocity and, in practice, some trade off between these operating considerations may be necessary. In one embodiment the voltage V supplied by the voltage supply 204 and capacitance of the capacitor 202 are selected to provide an energy of 100 kJ via the current iₜ to the poloidal magnetic field.

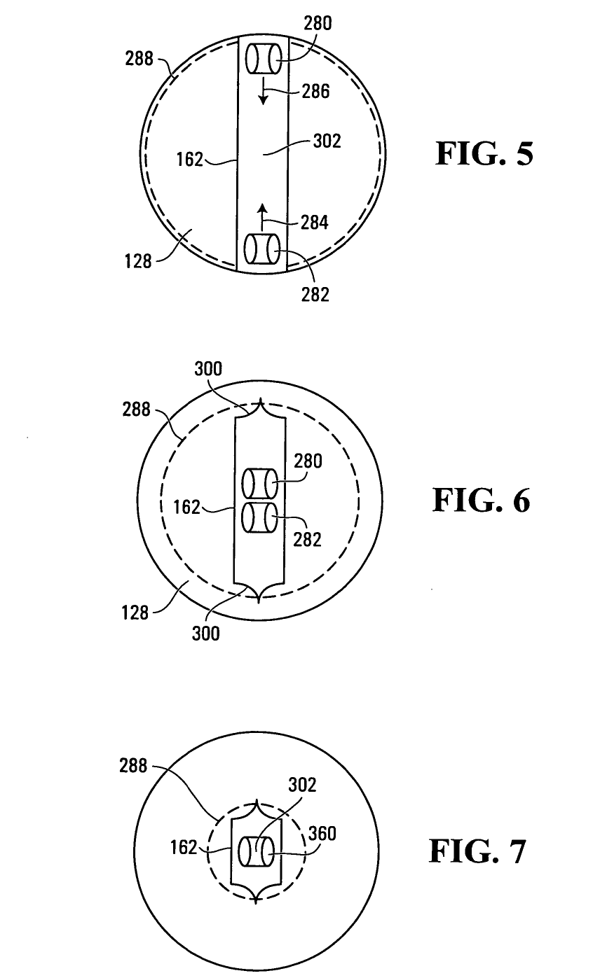

Returning now to FIG. 8, as shown at 258, the respective magnetized plasmas generated by the plasma generators 106 and 108 have respective velocities that propel the respective magnetized plasmas into the vortex 162. Referring to FIG. 5, a first magnetized plasma 280 and a second magnetized plasma 282 are simultaneously introduced into the vortex 162 by plasma generators 106 and 108 and are propelled towards each other in the directions indicated by arrows 286 and 284 respectively.

As shown at 260, the pressure wave is generated in the liquid medium 128. The pressure wave is generated by the plurality of pressure wave generators 104, which are activated at block 254 by releasing their respective pistons 152. The pistons are accelerated under fluid pressure applied to respective fluid ports 156, to impact the wall 120 of the vessel 102, thus causing a plurality of pressure waves to be generated in the liquid medium 128. Since the pistons 152 will typically be slower than the respective velocities that propel the respective magnetized plasmas into the vortex 162, the actual activation of the pressure wave generators at block 254 is timed such that the generation of the pressure wave in the liquid medium 128 only occurs after the magnetized plasmas have been introduced into the vortex 162. Therefore, activating the pressure wave generation at block 254 may occur before generating the magnetized plasma at block 256 (or introducing the magnetized plasma into the vortex at block 258), while generating the pressure wave in the liquid medium at block 260, only occurs after introducing the magnetized plasma at block 258.

Referring to FIG. 5, the plurality of pressure waves generated by the pressure wave generators 104 combine to define a pressure wavefront 288 in the liquid medium 128. Individual pressure wave generators 104 in the plurality of pressure wave generators may be configured to impact the wall 120 at differing times and with different amounts of kinetic energy, such that the resulting pressure wavefront 288 propagates in the liquid medium 128 and converges to a desired location in the vortex 162, which may be the center 302 of the vortex.

Referring to FIG. 6, the pressure wavefront 288 propagates through the liquid medium 128, enveloping and converging on the magnetized plasmas 280 and 282. Advantageously, the enveloping pressure wavefront confines the magnetized plasmas 280 and 282 within the converging pressure wavefront. At the same time the magnetized plasmas 280 and 282 continue to move toward each other and the vortex is pinched off behind the magnetized plasmas by the action of the pressure wave that collapses the vortex 162 in the regions 300. Referring to FIG. 7, the magnetized plasmas 280 and 282 collide at a center 302 of the vortex 162 forming a combined magnetized plasma 360. The collision of the magnetized plasmas 280 and 282 also serves to immobilize the combined magnetized plasma at the center 302 of the vortex 162.

The pressure wavefront enveloping the combined magnetized plasma 360 continues to converge on the magnetized plasmas, increasing the temperature and pressure of the fusionable materials contained by the magnetic field to a sufficient extent to initiate fusion reactions in the fusionable material.

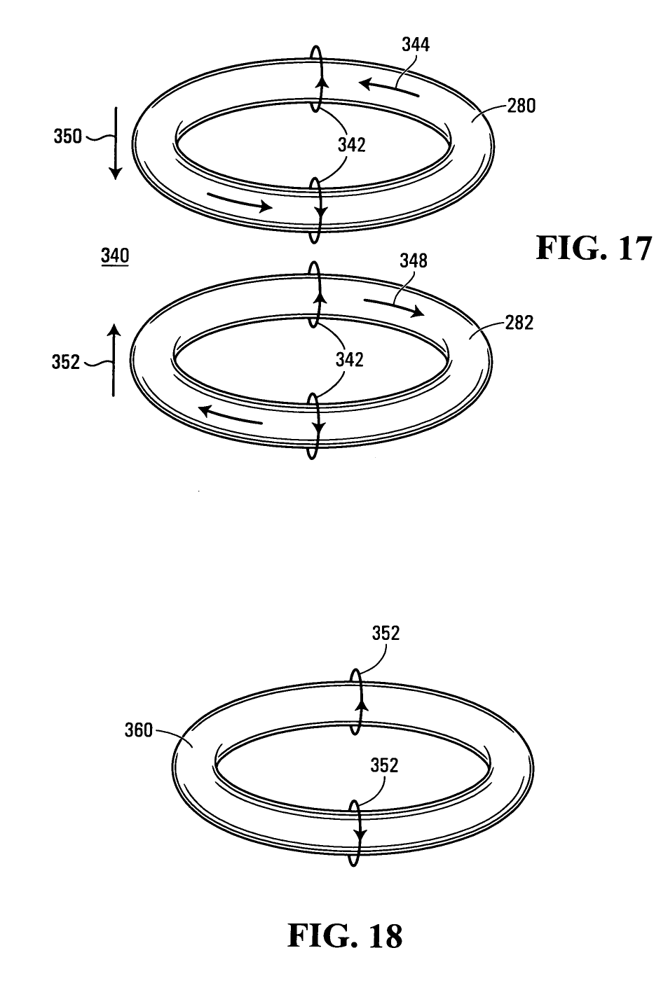

Referring to FIG. 17, the magnetized plasmas 280 and 282 generated by the plasma generators 106 and 108 (shown in FIG. 2) are shown in greater detail at 340. The first plasma generator 106 is configured to generate the magnetized plasma 280 so that it has a velocity in the direction of arrow 350 and is confined in a toroidal shape by magnetic fields having a poloidal magnetic field component 342 and an anti-clockwise toroidal magnetic field component 344. The second plasma generator 108 is configured to generate the magnetized plasma 282 so that it has a velocity in the direction of arrow 352 and is confined in a toroidal shape by magnetic fields having a poloidal magnetic field component 346 and a clockwise toroidal magnetic field component 348. Advantageously, since the vortex is generated in a conducting liquid medium 128, the magnetized plasmas 280 and 282 are coaxially guided in the vortex by repulsion forces between the conducting liquid medium at the edges of the tubular vortex and the magnetic fields sustained in the magnetized plasmas 280 and 282. These repulsion forces ensure that the magnetized plasmas 280 and 282 are coaxially aligned prior to collision. Furthermore the plasma generators 106 and 108 may be adjusted such that the respective velocities of the magnetized plasmas 280 and 282 are substantially equal, thus causing the plasmas to collide at the center of the vortex.

Referring to FIG. 18, the collision of the magnetized plasmas 280 and 282 causes the combined magnetized plasma 360 to be formed. Since the respective velocities of the magnetized plasmas 280 and 282 are substantially equal but opposite, the velocities will cancel and the combined magnetized plasma 360 will be substantially stationary. The toroidal magnetic field components 344 and 348, being oriented in opposing directions, will also substantially cancel Advantageously, the cancellation of the toroidal magnetic field components 344 and 348 causes energy to be released which at least partially heats the combined magnetized plasma 360. The poloidal magnetic field components 342 and 346 of respective magnetized plasmas 280 and 282, being of the same orientation, will combine and reinforce each other thus causing the combined magnetized plasma 360 to be confined by the combined poloidal magnetic field 352. In one embodiment the diameter of the combined magnetized plasma 360 may be approximately 10 cm.

Advantageously, the operation of the plasma generators 106 and 108 to generate magnetized plasmas 280 and 282 having opposite velocities and opposite toroidal magnetic field components 344 and 348 causes the stationary combined magnetized plasma 360 to be produced at the center 302 of the vortex 162. The stationary combined magnetized plasma 360 is also pre-heated by cancellation of energy in the respective toroidal magnetic field components and may then be further heated and compressed by enveloping the combined plasma in a converging wavefront, thus elevating the temperature and pressure of the quantity of fusionable materials 320 in the combined magnetic plasma to a sufficient extent to initiate fusion reactions therein. One advantage of producing the stationary combined magnetized plasma 360 is that it reduces the need for precise timing of the convergence of the pressure wavefront 288 on the combined magnetized plasma. However, in other embodiments a single magnetized plasma may be generated and introduced into the vortex. A pressure wave may then be generated that causes a wavefront to converge on a desired location in the vortex, at the same time the single magnetized plasma reaches the desired location in the vortex, thus compressing the single magnetized plasma and initiating fusion reactions therein.

The propagation velocity of the pressure wavefront 288 is governed by the speed of sound which is fixed for a particular choice of the liquid medium 128. In the spherical geometry shown in FIGS. 5-7 the magnetized plasmas must be generated and introduced into the vortex 162 prior to the initiation of the pressure wave, since the pressure wavefront 288 collapses the vortex as it advances. For a liquid medium having a slow speed of sound, the elapsed time between generation of the magnetized plasmas 280 and 282, and the compression by the converging pressure wavefront may allow the plasmas to cool prior to initiation fusion reactions therein.

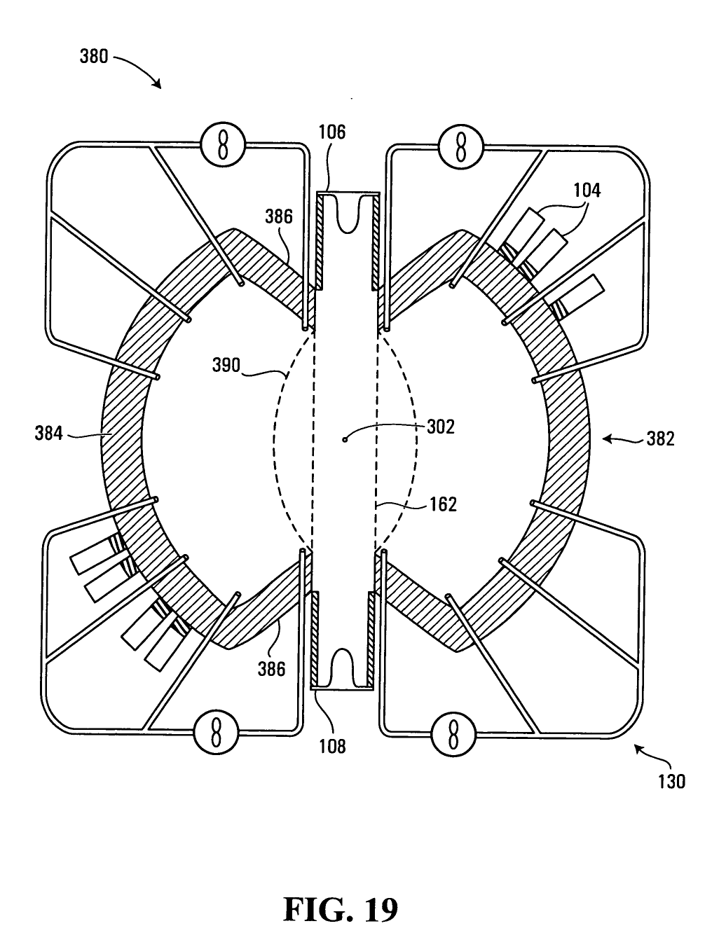

Referring to FIG. 19 an alternative embodiment of a fusion reactor is shown at 380. The fusion reactor 380 includes a vessel 382, a plurality of pressure wave generators 104, a first plasma generator 106, and a second plasma generator 108. The fusion reactor also includes a plurality of vortex generators 130 (only one shown). In this embodiment the fusion reactor includes a vessel 382 having a central spherical wall portion 384 and frustoconical shaped wall potions 386 top and bottom.

The operation of the fusion reactor 380 is similar to the operation of the fusion reactor 100 described in relation to FIG. 2. However, in this embodiment the frustoconical wall portions 386 cause the plasma generators 106 and 108 to be located closer to the center 302 of the vortex 162. Advantageously, in this embodiment the pressure wave may be generated such that the magnetized plasmas only need be introduced into the vortex once the pressure wavefront reaches a position shown in broken outline at 390, thus allowing the magnetized plasmas to be generated after the pressure wave has been generated. Individual pressure wave generators 104 in the plurality of pressure wave generators may be configured to impact the wall 384 at differing times and with different amounts of kinetic energy, such that the resulting pressure wavefront envelopes the magnetized plasmas such that the convergence thereon is substantially symmetrical.

While specific embodiments of the invention have been described and illustrated, such embodiments should be considered illustrative of the invention only and not as limiting the invention as construed in accordance with the accompanying claims.

What is claimed is:

1. A method of initiating a fusion reaction in a magnetized plasma of fusionable material located in a vortex in a liquid medium, the method comprising causing a pressure wavefront in the liquid medium to envelope the magnetized plasma and to converge on the magnetized plasma to impart sufficient energy to the fusionable material to initiate fusion in the fusionable material.

2. The method of claim 1 wherein causing said pressure wavefront to envelope and converge comprises generating a pressure wave having a substantially spherical wavefront.

3. The method of claim 1 wherein causing said pressure wavefront to envelope and converge comprises generating a pressure wave having a wavefront that converges on a position at the center of the vortex.

4. The method of claim 1 wherein causing said pressure wavefront to envelope and converge comprises generating a plurality of pressure waves, said plurality of pressure waves combining to form said pressure wavefront.

5. The method of claim 4 wherein generating said plurality of pressure waves comprises causing a plurality of moveable pistons to impact an outside surface of a vessel containing the liquid medium.

6. The method of claim 5 wherein causing said plurality of moveable pistons to impact said outside surface of said vessel comprises accelerating said moveable pistons from respective initial positions, said respective initial positions being spaced apart from said vessel.

7. The method of claim 6 wherein accelerating said moveable pistons from said respective initial positions comprises applying a fluid pressure thereto.

8. The method of claim 1 further comprising generating a poloidal magnetic field in the fusionable material such that the fusionable material is confined by said poloidal magnetic field.

9. The method of claim 8 further comprising introducing the magnetized plasma into the vortex.

10. The method of claim 9 wherein introducing the magnetized plasma comprises propelling the magnetized plasma into an open end of the vortex.

11. The method of claim 10 wherein propelling the magnetized plasma comprises generating a toroidal magnetic field that interacts with the magnetized plasma to impart a force thereon.

12. The method of claim 10, wherein causing said pressure wavefront to envelope and converge comprises generating a pressure wave having a wavefront that reaches a target position in the vortex after the magnetized plasma has reached said target position in the vortex.

13. The method of claim 8, further comprising generating a first magnetized plasma and generating a second magnetized plasma.

14. The method of claim 13, further comprising introducing said first magnetized plasma into a first open end of the vortex and introducing said second magnetized plasma into a second open end of the vortex.

15. The method of claim 14, further comprising causing said first magnetized plasma and said second magnetized plasma to collide at a target position located substantially midway between said first and said second open ends of the vortex.

16. The method of claim 15, wherein causing said pressure wavefront comprises generating a pressure wave having a wavefront that reaches said target position after said first magnetized plasma and said second magnetized plasma have collided at said target position.

17. The method of claim 15 wherein causing said first magnetized plasma and said second magnetized plasma to collide comprises generating respective toroidal magnetic fields in said magnetized plasmas, said respective toroidal magnetic fields causing respective propelling forces to be imparted on said first and said second magnetized plasmas.

18. The method of claim 17 wherein generating respective toroidal magnetic fields comprises generating respective toroidal magnetic fields that are oriented such that when said first and said second magnetized plasmas collide, said respective toroidal magnetic fields are cancelled, causing magnetic energy to be converted into heat energy in said first and said second magnetized plasmas.

19. The method of claim 1 wherein the liquid medium is contained in a vessel having a generally circular cross section and further comprising generating the vortex by causing the liquid medium to be rotated about an axis of said vessel.

20. The method of claim 19 further comprising applying a vacuum to the vortex to evacuate the vortex.

21. The method of claim 19 wherein causing the liquid medium to be rotated comprises extracting a portion of the liquid medium from said vessel through an aperture located in said vessel proximate said axis and causing said portion of the liquid medium to be re-introduced into said vessel as a plurality of flow streams oriented in a direction aligned with a desired rotational direction of the liquid medium.

22. The method of claim 21, wherein causing the liquid medium to be rotated comprises orienting said flow streams such that a substantially uniform rotational velocity is imparted to all portions of the liquid medium.

23. A fusion reactor apparatus for initiating a fusion reaction in a fusionable material, the apparatus comprising:
a vessel for containing a liquid medium;
means for generating a vortex in said liquid medium;
means for introducing a magnetized plasma of the fusionable material into said vortex; and
means for causing a pressure wavefront in said liquid medium to envelope said magnetized plasma and to converge on said magnetized plasma to impart sufficient energy to the fusionable material to initiate fusion in the fusionable material.

24. The apparatus of claim 23 wherein said means for causing said pressure wavefront to envelope and converge comprises means for generating a pressure wave having a substantially spherical wavefront.

25. The apparatus of claim 23 wherein said means for causing said pressure wavefront to envelope and converge comprises means for generating a pressure wave having a wavefront that converges on a position at the center of the vortex.

26. The apparatus of claim 23 wherein said means for causing said pressure wavefront to envelope and converge comprises means for generating a plurality of pressure waves, said plurality of pressure waves combining to form said pressure wavefront.

27. The apparatus of claim 26 wherein said means for generating said plurality of pressure waves comprises means for causing a plurality of moveable pistons to impact an outside surface of said vessel.

28. The apparatus of claim 27 wherein said means for causing said plurality of moveable pistons to impact said outside surface of said vessel comprises means for accelerating said moveable pistons from respective initial positions, said respective initial positions being spaced apart from said vessel.

29. The apparatus of claim 28 wherein said means for accelerating said moveable pistons from said respective initial positions comprises means for applying a fluid pressure thereto.

30. The apparatus of claim 23 further comprising means for generating a magnetized plasma.

31. The apparatus of claim 30 wherein said means for generating said magnetized plasma comprises means for generating a poloidal magnetic field in the fusionable material such that the fusionable material is confined by said poloidal magnetic field.

32. The apparatus of claim 31 wherein said means for introducing said magnetized plasma comprises means for propelling said magnetized plasma into an open end of said vortex.

33. The apparatus of claim 32 wherein said means for propelling said magnetized plasma comprises means for generating a toroidal magnetic field that interacts with said magnetized plasma to impart a force thereon.

34. The apparatus of claim 32, wherein said means for causing said pressure wavefront to envelope and converge comprises means for generating a pressure wave having a wavefront that reaches a target position in said vortex after said magnetized plasma has reached said target position in said vortex.

35. The apparatus of claim 30 wherein said means for generating said magnetized plasma comprises means for generating a first magnetized plasma and means for generating a second magnetized plasma.

36. The apparatus of claim 35 further comprising means for introducing said first magnetized plasma into a first open end of said vortex and means for introducing said second magnetized plasma into a second open end of said vortex.

37. The apparatus of claim 36 further comprising means for causing said first magnetized plasma and said second magnetized plasma to collide at a target position located substantially midway between said first and said second open ends of said vortex.

38. The apparatus of claim 37 wherein said means for causing said pressure wavefront to envelope and converge comprises means for generating a pressure wave having a wavefront that reaches said target position after said first magnetized plasma and said second magnetized plasma have collided at said target position.

39. The apparatus of claim 37 wherein said means for causing said first magnetized plasma and said second magnetized plasma to collide comprises means for generating respective toroidal magnetic fields in said magnetized plasmas, said respective toroidal magnetic fields operable to cause respective propelling forces to be imparted on said first and said second magnetized plasmas.

40. The apparatus of claim 39 wherein said means for generating respective toroidal magnetic fields are operably configured to generate respective toroidal magnetic fields that are oriented such that when said first and said second magnetized plasmas collide, said respective toroidal magnetic fields are cancelled, causing magnetic energy to be converted into heat energy in said first and said second magnetized plasmas.

41. The apparatus of claim 23 wherein said means for generating said vortex comprises means for causing said liquid medium to be rotated about an axis of said vessel.

42. The apparatus of claim 41 further comprising means for applying a vacuum to said vortex to evacuate said vortex.

43. A fusion reactor apparatus for initiating a fusion reaction in a fusionable material, the apparatus comprising:
a vessel operable to contain a liquid medium;
a vortex generator operable to generate a vortex in said liquid medium;
a plasma generator operable to generate a magnetized plasma of the fusionable material and to introduce said magnetized plasma into said vortex; and
a pressure wave generator operably configured to cause a pressure wavefront in said liquid medium to envelope said magnetized plasma and to converge on said magnetized plasma to impart sufficient energy to the fusionable material to initiate fusion in the fusionable material.

44. The apparatus of claim 43 wherein said vessel is substantially spherical and said pressure wave generator is operable to generate a pressure wave having a substantially spherical wavefront.

45. The apparatus of claim 43 wherein said pressure wave generator comprises a plurality of moveable pistons operably configured to impact an outside surface of said vessel to generate a plurality of pressure waves, said plurality of pressure waves combining to form said pressure wavefront.

46. The apparatus of claim 43 wherein said plasma generator further comprises a magnetic field generator for generating a poloidal magnetic field, the poloidal magnetic field being operable to confine the fusionable material.

47. The apparatus of claim 43 wherein said plasma generator further comprises a toroidal magnetic field generator for generating a toroidal magnetic field for propelling said magnetized plasma into said vortex bye interacting with said magnetized plasma to impart a force thereon.

48. The apparatus of claim 47 wherein said pressure wave generator is operably configured to generate a pressure wave having a wavefront that reaches a target position in said vortex after said magnetized plasma has reached said target position in said vortex.

49. The apparatus of claim 48 wherein said target position is located at a center of said vortex.

50. The apparatus of claim 43 wherein said plasma generator comprises a first plasma generator for generating a first magnetized plasma and a second plasma generator for generating a second magnetized plasma.

51. The apparatus of claim 50 wherein said first plasma generator is located on a first wall portion and said second plasma generator is located on a second wall portion, said first and said second wall portions being joined by a third wall portion, said first and said second wall potions having a frustoconical shape facilitating introduction of the magnetized plasma into said vortex after causing said pressure wavefront to envelope and converge in said liquid medium.

52. The apparatus of claim 50 wherein said vortex has first and second open ends located on opposite sides of said vortex, said first plasma generator being disposed to introduce said first magnetized plasma into said first open end of said vortex and said second plasma generator being disposed to introduce said second magnetized plasma into said second open end of said vortex.

53. The apparatus of claim 52 wherein said first plasma generator and said second plasma generator have respective toroidal field generators, said respective field generators being operably configured to impart respective forces on said first and said second magnetized plasmas such that said first magnetized plasma and said second magnetized plasma collide at a target position located substantially midway between said first and said second open ends of said vortex.

54. The apparatus of claim 53 wherein said pressure wave generator is operably configured to generate a pressure wave having a wavefront that reaches said target position after said first magnetized plasma and said second magnetized plasma have collided at said target position.

55. The apparatus of claim 53 wherein said respective toroidal field generators are operably configured to generate respective toroidal magnetic fields that are oriented such that when said first and said second magnetized plasmas collide, said respective toroidal magnetic fields are cancelled, causing magnetic energy to be converted into heat energy in said first and said second magnetized plasmas.

56. The apparatus of claim 43 wherein said vortex generator is operably configured to cause said liquid medium to be rotated about an axis of said vessel.

57. The apparatus of claim 56 wherein said vortex generator comprises:
a first aperture in said vessel proximate said axis;
a plurality of jets located inside said vessel;
a pump for extracting said liquid medium through said aperture and for reintroducing said liquid medium into said vessel through said plurality of jets, said jets being oriented in a direction aligned with a desired rotational direction of said liquid medium.

58. The apparatus of claim 56 further comprising a vacuum source in communication with said vortex for evacuating said vortex.
